(19) United States
(12) Patent Application Publication
(10) Pub. No.: US 2014/0366444 A1
(43) Pub. Date: Dec. 18, 2014

(54) PROPAGATION CONTAINER FOR PLANTS AND PROPAGATION PLATE HAVING SEVERAL SUCH PROPAGATION CONTAINERS

(71) Applicant: Juergen Kubern, Muenchen (DE)

(72) Inventor: Juergen Kubern, Muenchen (DE)

(21) Appl. No.: 14/007,382

(22) PCT Filed: Feb. 3, 2012
(86) PCT No.: PCT/EP2012/000501

§ 371 Date: Oct. 17, 2013

(30) Foreign Application Priority Data
Mar. 25, 2011 (DE) 10 2011 015 124.9

(51) Int. Cl. A01G 9/02; A01G 9/10

(52) U.S. Cl. CPC A01G 9/021; A01G 9/104
USPC 47/73

(57) ABSTRACT

The present disclosure relates to a propagation container comprising a circumferential wall, which bounds at least two cavities arranged next to one another, each cavity having a center longitudinal axis and the cavities being open to each other along part of the lateral circumferential surface thereof, wherein each cavity has an upper access opening and a bottom, between which upper access opening and bottom of each cavity run at least two retaining ribs that extend substantially vertically and are spaced from each other in the circumferential direction, which retaining ribs protrude radially from the circumferential wall into the associated cavity and define a cylindrical or conical frustrum-shaped accommodating opening centered at the center longitudinal axis of the associated cavity, and the mutual distance of the center longitudinal axes is dimensioned in such a way that the lateral circumferential surfaces of the accommodating openings touch or overlap.

The invention relates to a propagation container for cultivating plants from in particular seeds or cuttings as well as to a propagation plate having a plurality of such propagation containers.

Propagation containers and propagation plates of the described type have been known for a long time. A propagation container is used to receive a culture medium, into which a seed or a cutting (optionally also a plurality of seeds and a plurality of cuttings) are introduced in order to cultivate a young plant. The cuttings may or may not have roots.

In recent times so-called mixed pots, planters and hanging baskets have made strong gains in market importance, i.e. garden containers for the end user that are planted with various varieties of one type of plant or with various types of plant. Typically these products are produced by separately cultivating and then planting together individual young plants of the various varieties or types in a garden container (pot, planter, hanging basket etc.). The young plants are conventionally cultivated by sowing seeds or by inserting a rootless cutting in a propagation pot that is suitable for cultivating young plants and may be for example a fibrous web pot (also known as a paper pot), a so-called Jiffypot® or a so-called Preforma® pot. A fibrous web pot is a substantially hollow-cylindrical container made of a fibrous web-like paper material that receives the culture medium material used to cultivate the young plant. A Jiffypot® is made of dried compressed peat, which is surrounded by a biodegradable net. When water is added, it swells and hence adopts its proper shape. A Preforma® pot is a shaped body that is pressed out of the culture medium material, for example peat, and an organic adhesive and may directly receive the seed or cutting. Fibrous web pots, Jiffypots® or Preforma® pots are not in themselves adequately stable and therefore have to be placed in each case into a propagation container that enables safe handling of the fibrous web pots, Jiffypots® or Preforma® pots provided with seeds or cuttings and allows the culture medium material to be supplied with the water needed for cultivation and optionally liquid feed etc. A propagation plate, also known as a tray, contains a plurality of such propagation containers (also known as cells) and enables efficient handling of all of the propagation pots contained in the propagation containers.

In order to produce mixed pots, planters and hanging baskets the desired different young plants, which have been cultivated in the previously described manner, have to be planted together in the garden container, e.g. a pot, planter or hanging basket, that is intended for sale, this conventionally being effected by a finished goods producer. Planting the desired, different young plants in each case into a pot or the like obviously involves a considerable logistical and organizational outlay. It also poses a considerable risk that the young plants planted in a pot are not always the correct ones.

Alternatively, from U.S. Pat. No. 7,891,134 B2 it is known to root cuttings of different varieties and/or types jointly in a single propagation pot. The important advantage of this procedure is that it clearly cuts down the work of the finished goods producer and prevents errors during the previously described subsequent planting-together of the desired young plants. A drawback is however that it is possible to jointly root only cuttings of varieties and types which during the root-growing stage have at least approximately identical cultivation requirements as regards temperature, water supply, culture medium material etc., and which moreover exhibit identical or at least similar growing properties.

The underlying object of the invention is to indicate a solution that also allows different varieties and/or types to be grown into young plants in a labor-saving manner.

This object is achieved according to the invention by a propagation container having the features described in claim 1. The propagation container according to the invention has a circumferential wall, which bounds at least two cavities arranged next to each other, each cavity having a center longitudinal axis. The cavities of the propagation container are open to each other along part of the lateral circumferential surface thereof and each cavity has an upper access opening and a bottom. Between the upper access opening and the bottom of each cavity run at least two retaining ribs that extend substantially vertically and are spaced from each other in the circumferential direction, which retaining ribs protrude radially from the circumferential wall into the associated cavity and define a cylindrical or conical-frustrum-shaped accommodating opening centered at the center longitudinal axis of the associated cavity. Here, by “substantially vertically” is meant that the retaining ribs need not necessarily extend precisely in a vertical direction. Rather, it may be necessary, for example if the propagation container is manufactured by a thermoforming method, for the retaining ribs to present a slight taper angle (for example 3.5 to 4 degrees) to enable trouble-free removal from the mold. The course of the retaining ribs also possibly has to be adapted to the external shape of the propagation pot used. If for example the propagation pot is conical frustrum-shaped, then the retaining ribs have to extend at least substantially parallel to the outside of such a propagation pot and are therefore arranged in an inclined manner while still however extending in a substantially vertical direction, i.e. from top to bottom in relation to the cavity. Each accommodating opening is intended to receive a propagation pot, which may be a fibrous web pot, a Jiffypot®, a Preforma® pot or the like. The mutual distance of the center longitudinal axes of the cavities of the propagation container is dimensioned in such a way that the lateral (virtual) circumferential surface of the accommodating openings touch or overlap one another. In this way, according to the invention it is guaranteed that the propagation pots introduced into the accommodating openings of a propagation container according to the invention are in mutual contact and/or are pressed against one another along part of their lateral circumferential surfaces. The roots that develop during cultivation of the young plants in the propagation pots therefore have the possibility of growing together with the roots of the adjoining propagation pot or pots and forming a cluster of propagation pots which, after intergrowth of the roots, may be removed as a unit from the propagation container and planted for example into a container intended for sale. Because according to the invention each young plant has its own propagation pot, it is easy to take account of the different requirements of the individual varieties and/or types of plants. Thus, for example each young plant may be propagated in the culture medium that is best for it. Also, each young plant may be supplied precisely with the requisite amount of water. It is moreover possible to supply each young plant individually with growth inhibitors or growth accelerators so that the rate of growth of different varieties and/or types situated in a propagation container may be equalized. Finally, each young plant may be supplied individually with specific liquid feeds, growth hormones, plant protection agents etc.

The mutual lateral contact of the propagation pots will normally, i.e. in the case of cylindrical propagation pots with a round outer wall, have the shape of a vertical line or a vertical strip but may also, in dependence upon the external shape of the propagation pots that are used, be two-dimensional, for example in the case of propagation pots that are rectangular or square in cross section. The mutual contact of the propagation pots also need not extend over their entire height, the important point being merely that the extent of the mutual contact is enough to enable sufficient roots to grow laterally from one propagation pot into an adjoining propagation pot in order to connect the propagation pots into a unit. It is self-evident that the propagation pots inserted into a propagation container according to the invention have to be fashioned in a way that enables the roots formed therein to grow out of the lateral circumferential surface of the propagation pot.

The retaining ribs of a propagation container according to the invention are used not only to laterally define an accommodating opening for a propagation pot but also to provide a distance between the lateral circumferential surface of a propagation pot and the circumferential wall of the propagation container. This allows air to flow to the greatest extent around a propagation pot located in the accommodating opening, this being advantageous for good growth of the young plant and preventing gray mould formation and root diseases. The retaining ribs moreover serve to support and correctly position, in particular center, a propagation pot located in an accommodating opening. It is thereby possible to ensure that all of the propagation pots are located in a position that is defined in relation to the respective propagation container, this being important for example for automating specific process steps such as for example initial hole formation, seed sowing or cutting insertion.

In one embodiment of a propagation container according to the invention the center longitudinal axes of the individual cavities of the propagation container are parallel to one another. Such an embodiment is appropriate when the propagation pots themselves have a cylindrical shape, such as for example the previously mentioned fibrous web pots. In another embodiment the center longitudinal axes of the cavities of the propagation container are oriented in such a way that they move apart from one another in a direction extending from the bottom of the propagation container to the upper access opening. Such an embodiment is suitable for example for conical frustrum-shaped Preforma pots. Each center longitudinal axis is then inclined outwards by half the taper angle relative to the vertical, so that the lateral circumferential surfaces of the propagation pots situated in the accommodating openings run parallel to one another in the region, in which they are in mutual contact.

In principle two retaining ribs per cavity are already sufficient to define the accommodating opening of this cavity in circumferential direction and to ensure that a propagation pot disposed in the accommodating opening is correctly positioned, i.e. is in particular laterally in contact with one or more propagation pots situated adjacent to it in the same propagation container. In a preferred embodiment of the propagation container three retaining ribs per cavity protrude radially from the circumferential wall and are preferably uniformly spaced apart from one another in circumferential direction. In this way, an even more reliable and defined positioning of a propagation pot in the accommodating opening is achieved.

It is not necessary for each retaining rib to extend over the entire height of a cavity. Particularly in the case of more than two retaining ribs per cavity the individual ribs may be arranged at different heights within the cavity and hence achieve good positioning of a propagation pot situated in the accommodating opening. However it is not disadvantageous if each retaining rib extends from the upper access opening to the bottom of a cavity. Secure positioning of a propagation pot situated in the accommodating opening is in any case achieved thereby. If the propagation container is to be manufactured for example from a plastic foil using a thermoforming method, such retaining ribs extending from the bottom up to the upper access opening are on the one hand advantageous for reasons of manufacture (good removability from the mold) and on the other hand lend the propagation container increased stability.

In preferred embodiments of the propagation container according to the invention the portion of each retaining rib that lies nearest to the upper access opening is configured so as to be chamfered conically inwards. This facilitates the introduction of a propagation pot into the accommodating opening and the correct positioning of a propagation pot in the accommodating opening.

The bottom of each cavity of a propagation container according to the invention preferably has a plurality of shoulders, the upper sides of which are disposed at the same level and together define an underside of the accommodating opening. In other words, a propagation pot introduced into the accommodating opening stands with its bottom on the upper sides of the said shoulders. According to a development of such a form of construction there are formed between the shoulders channels, which run into a drainage hole in the bottom of the cavity. The channels enable water to be supplied to and/or drained from the propagation pot and simultaneously ensure trouble-free ventilation of the culture medium base. Preferably all of the channels of a propagation container run into a common drainage hole.

Particularly preferred developments of propagation containers according to the invention comprise three, four or five cavities, i.e. they are designed to accommodate three, four or five propagation pots. For example, in the case of a propagation container having three cavities, the latter may be arranged approximately in the shape of a three-leaf clover, in the case of four cavities these may be arranged in the shape of a square, in the case of five cavities these may be arranged in such a way that a central cavity is surrounded by the remaining four cavities, and so on. In principle it is possible to provide more than five cavities in a propagation container, with for example six or seven cavities also being conceivable, but with an increasing number of cavities, depending upon their arrangement, it will possibly become more difficult to ensure the desired lateral contact of the propagation pots.

The initially stated object is achieved according to the invention also by a propagation plate having a plurality of the previously described propagation containers. In a preferred embodiment of a propagation plate according to the invention each propagation container has three cavities, which together in plan view form a cloverleaf-like shape. The propagation containers are arranged identically aligned in lines in the propagation plate in such a way that in line direction in each case two center longitudinal axes of the cavities of a propagation container are situated on a common line, while the third cavity is situated underneath. In this way the position of each cavity in the propagation plate is precisely defined and introducing and removing propagation pots into/from the propagation containers may easily be automated, for example by means of a handling robot. Such a handling robot then moves from cavity to cavity in that it is displaced solely in line direction and at the end of the line is offset by a specific dimension in order to be able to move towards the next cavities disposed in line direction. Other arrangements are alternatively possible.

A preferred embodiment of a propagation container according to the invention and of a plurality of such propagation containers that are combined on a propagation plate is described in detail below with reference to the accompanying diagrammatic figures. These show:

FIG. 1 a three-dimensional view obliquely from above of an embodiment of a propagation container according to the invention having three cavities,

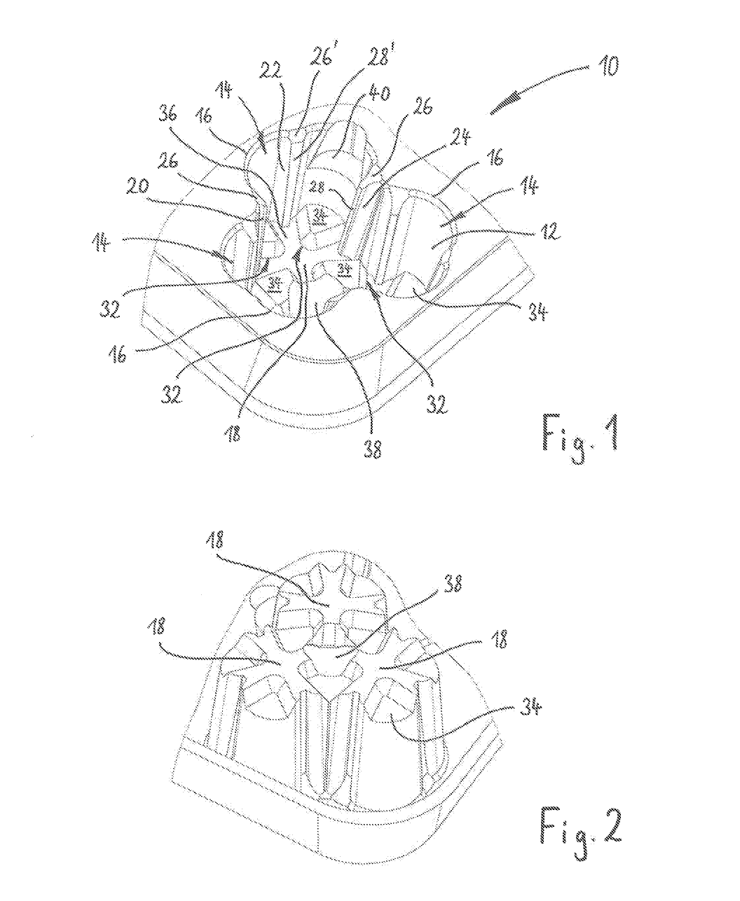

FIG. 2 a three-dimensional view obliquely from below of the propagation container of FIG. 1,

FIG. 3 a plan view of the propagation container of FIG. 1, and

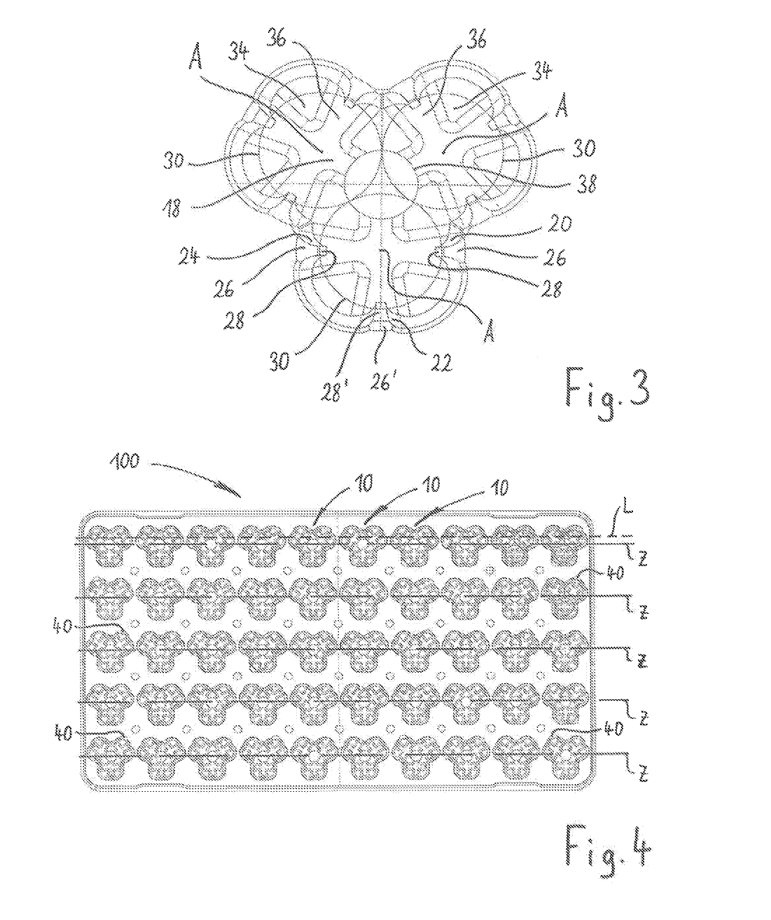

FIG. 4 a plan view of a propagation plate having fifty propagation containers according to FIG. 1.

FIGS. 1 to 3 show different views of a propagation container generally denoted by 10. The propagation container 10 in FIGS. 1 and 2 forms part of a propagation plate 100, which will be described in greater detail with reference to FIG. 4 and comprises a total of fifty such propagation containers 10, but the propagation container 10 may easily be configured also in such a way that it is capable of individual independent handling, i.e. does not form part of a propagation plate having a plurality of propagation containers.

The propagation container 10 has a lateral circumferential wall 12, which bounds a plurality of cavities, in the illustrated embodiment three cavities 14, which are arranged next to one another and, as represented, are open towards one another along part of their lateral circumferential surface. Each cavity 14 has an upper access opening 16 and a bottom 18 that is connected to the lower end of the circumferential wall 12. The three access openings 16 together form the open top of the propagation container 10, while the three bottoms 18 together form a base and hence the underside of the propagation container 10.

Between the upper access opening 16 and the bottom 18 of each cavity 14 run three substantially vertically extending retaining ribs 20, 22, 24, which are mutually spaced in circumferential direction and protrude radially from the circumferential wall 12 into the associated cavity 14. The two retaining ribs 20 and 24 of each cavity are disposed, viewed in circumferential direction, in each case at the end of the lateral circumferential surface of each cavity 14 defined by the circumferential wall 12 and are of an identical configuration. A portion 26 of each retaining rib 20, 24 that adjoins the upper access opening 16 is configured so as to be chamfered conically inwards. Viewed in radial direction, each retaining rib 20, 24 tapers from the outside in as far as a radially inwardly situated support surface 28, which faces the interior of the cavity 14.

Each cavity 14 has an, in the present case, vertically disposed center longitudinal axis A. The two retaining ribs 20, 24, more precisely their support surfaces 28, between them define an accommodating opening 30, which in the present case is circular in cross section, almost cylindrical but in fact slightly conical frustrum-shaped and is centered at the center longitudinal axis A of the associated cavity 14. The slightly conical frustrum-like shape of the accommodating opening 30 is produced in the illustrated embodiment by a slight taper angle of 3.5 to 4 degrees that the retaining ribs 20, 24 have, i.e. the retaining ribs 20, 24 close to the bottom 18 of each cavity 14 protrude radially a little further into the cavity 14 than in their upper region adjacent to the access opening 16. Such a taper angle is necessary in the illustrated embodiment because the illustrated propagation container 10 is manufactured in one piece from a plastic foil using a thermoforming method and has to be removed from the thermoforming mold (not shown). Given a different method of manufacture the retaining ribs 20, 24 may straightforwardly alternatively define a precisely cylindrical accommodating opening, if so desired.

The mutual distance of the, in the present case, vertical and hence mutually parallel center longitudinal axes A of the cavities 14 is dimensioned in such a way that the accommodating openings 30, more precisely their lateral circumferential surfaces, are in mutual contact (see FIG. 3). Alternatively the mutual distance of the center longitudinal axes A may be selected in such a way that the lateral circumferential surfaces of the accommodating openings 30 slightly overlap (not shown). The purpose of such a development will be explained in greater detail further below in connection with the functional description of the propagation container 10.

The further retaining rib 22, which is disposed with identical spacing from the retaining ribs 20, 24 in circumferential direction, may be of exactly the same design as the retaining ribs 20, 24. In the present embodiment, however, the middle retaining rib 22 extends radially not quite as far into the cavity 14 as the retaining ribs 20, 24, this being apparent from the different shape of the upper chamfer 26′ and the wider support surface 28′ thereof. It is therefore only slightly further down that the support surface 28′ of the retaining rib 22 comes into contact with the lateral circumferential surface of the accommodating opening 30.

Formed at the bottom 18 of each cavity 14 is a plurality of shoulders 32, which in the present case are approximately pie-slice-shaped and the upper sides 34 of which are disposed at one and the same height level, so that together they define an underside of the accommodating opening 30. The upper sides 34 may be disposed in a common plane and hence parallel to one another, though they may alternatively be disposed—each on the same level—in such a way that they extend in radial direction with a slight downward slope from the outside in.

Formed between the shoulders 32 are channels 36, which are bounded by the bottom 18 and lateral surfaces of the shoulders 32 and which in the illustrated embodiment all run into a common drainage hole 38. Alternatively each cavity 14 may have its own drainage hole.

There now follows a functional description of the propagation container 10 and the previously described elements thereof. Each accommodating opening 30, which is defined by the retaining ribs 20, 22 and 24 and in the illustrated embodiment is almost cylindrical, is used to receive a propagation pot for cultivating young plants, the diameter of the propagation pot corresponding to the diameter of the accommodating opening 30 defined by the retaining ribs 20 and 24. The illustrated propagation container 10 is designed for propagation pots in the form of so-called fibrous web pots. As already described in the introduction, a fibrous web pot is a hollow-cylindrical shaped body with a circular cross section, which is made from a fibrous paper web and into which a suitable culture medium for propagating young plants, such as soil and/or peat material, is introduced. Three fibrous web pots filled with a desired culture medium are then introduced into the three accommodating openings 30 of the propagation container 10. In this case the retaining ribs 20 and 24 of each cavity 14 in conjunction with the retaining rib 22 ensure that the lateral circumferential surfaces of the propagation pots, here in the form of fibrous web pots, are in mutual contact along a vertical line and/or along a vertical strip. If the mutual distance of the center longitudinal axes A of the cavities 14 is selected in such a way that the lateral circumferential surfaces of the accommodating openings 30 mutually overlap, then the outer circumferential surfaces of the propagation pots disposed in the accommodating openings 30 are even pressed against one another with simultaneous corresponding deformation of the circumferential surface thereof.

Independently of whether the circumferential surfaces of the propagation pots are pressed against one another or are merely in mutual contact, it is however guaranteed by means of the propagation container 10 that roots, which develop during cultivation in the culture medium material and grow also laterally out of the propagation pot, may connect to roots growing laterally out of an adjacent propagation pot and/or may even grow into the laterally adjacent propagation pot. Thus, during cultivation the three propagation pots situated in the accommodating openings 30 grow into a unit, which at a desired time may be removed from the propagation container 10 and planted into a different garden container, for example into a hanging basket intended for sale.

The shoulders 32, in combination with the channels 36 formed between them and the drainage hole 38, ensure that the bottom region of a propagation pot situated in an accommodating opening 30 is not standing “in water” and is always well ventilated. Laterally, good ventilation is ensured by means of the retaining ribs 20, 22, 24, which with their support surfaces 28, 28′ have only a slight contact surface with the propagation pot and leave free a substantially annular hollow space around a propagation pot between the circumferential side of the propagation pot and the circumferential wall 12 of the propagation container 10. In this way gray mould formation and/or rotting processes are effectively avoided.

It is self-evident that the accommodating openings 30 need not be almost circular-cylindrical, as represented and described here, but may have any shape that is prescribed by the shape of the propagation pot used. If for example conical frustrum-shaped propagation pots are used, the center longitudinal axes A of the cavities 14 must each be inclined outwards in such a way that the circumferential surfaces of such propagation pots extend parallel to one another in the region, in which they are to be in mutual contact. Equally the retaining ribs 20, 22, 24 are then to be configured in such a way that that they define a conical frustrum-shaped accommodating opening 30 that is centered at this inclined center longitudinal axis A.

For the sake of more efficient handling, propagation containers 10 are generally not produced individually but form part of a so-called propagation plate. FIG. 4 shows such a propagation plate 100, in which in each case fifty of the previously described propagation containers 10 are disposed, namely in five lines Z each comprising ten propagation containers 10. To allow automated filling of such a propagation plate 100, the propagation containers 10 are arranged not randomly distributed on the propagation plate 100 but in such a way that the center longitudinal axes A of their cavities 14 each succeed one another in line direction, wherein in line direction the two center longitudinal axes A of the, in FIG. 4, in each case upper cavities 14 of a propagation container 10 are situated on a common line L, while the center longitudinal axes A of the in each case lower cavities 14 of the propagation containers 10 are situated likewise on a common line that extends below and parallel to the line L.

To enable a plurality of empty propagation plates 100 to be stacked one on top of the other without becoming jammed, in some of the propagation containers 10 stacking cams 40 are formed, which, when the propagation plates 100 are stacked one on top of the other, provide a defined stop and prevent the stacked propagation plates 100 from sliding too far into one another.

1-12. (canceled)

13. A propagation container, comprising:
a circumferential wall, which bounds at least two cavities arranged next to one another, each cavity having a center longitudinal axis and the cavities being open to each other along part of a lateral circumferential surface thereof,
wherein each cavity has an upper access opening and a bottom,
wherein between the upper access opening and the bottom of each cavity run at least two retaining ribs that extend substantially vertically and are spaced from each other in a circumferential direction, the retaining ribs protrude radially from the circumferential wall into the associated cavity and define a cylindrical or conical frustrum-shaped accommodating opening centered at the center longitudinal axis of the associated cavity, and
wherein the mutual distance of the center longitudinal axes is dimensioned in such a way that the lateral circumferential surfaces of the accommodating openings touch or overlap.

14. The propagation container according to claim 13, wherein the center longitudinal axes of the cavities are parallel to one another.

15. The propagation container according to claim 13, wherein the center longitudinal axes of the cavities move apart from one another in a direction extending from the bottom to the upper access opening.

16. The propagation container according to claim 13, wherein three retaining ribs per cavity protrude from the circumferential wall, the retaining ribs being uniformly spaced apart from one another in circumferential direction.

17. The propagation container according to claim 13, wherein each retaining rib extends from the upper access opening to the bottom.

18. The propagation container according to claim 17, wherein each retaining rib is chamfered conically inwards in a portion that adjoins the upper access opening.

19. The propagation container according to claim 13, wherein the bottom of each cavity has a plurality of shoulders, the upper sides of which are disposed on the same level and together define an underside of the accommodating opening.

20. The propagation container according to claim 19, wherein channels that run into a drainage hole in the bottom are formed between the shoulders.

21. The propagation container according to claim 20, wherein all of the channels of a propagation container run into a common drainage hole.

22. The propagation container according to claim 13, further comprising at least one of three cavities, four cavities and five cavities.

23. A propagation plate, including a plurality of propagation containers according to claim 13.

24. The propagation plate according to claim 23, wherein each propagation container comprises three cavities, which together in plan view form a cloverleaf-like shape.

25. The propagation plate according to claim 23, wherein the propagation containers are disposed identically aligned in lines in the propagation plate.

26. The propagation plate according to claim 23, wherein in line direction in each case two center longitudinal axes of the cavities of a propagation container are situated on a common line.
